(19) United States
(12) Patent Application Publication
(10) Pub. No.: US 2018/0258789 A1
(43) Pub. Date: Sep. 13, 2018

(54) SYSTEM AND METHOD FOR TRANSITION PIECE SEAL

(71) Applicant: General Electric Company, Schenectady, NY (US)

(72) Inventors: Rahul Anil Bidkar, Niskayuna, NY (US); Neelesh Nandkumar Sarawate, Schenectady, NY (US); Kevin McMahan, Greer, SC (US); Ronald Chila, Schenectady, NY (US)

(21) Appl. No.: 15/452,473

(22) Filed: Mar. 7, 2017

(51) Int. Cl. F01D 25/12; F01D 9/02; F01D 11/00; F04D 29/54

(52) U.S. Cl. CPC F01D 25/12; F01D 9/023; F01D 11/003; F05D 2260/201; F05D 2220/32; F05D 2240/35; F04D 29/545

(57) ABSTRACT

A system includes a web plate axially disposed between a transition piece and a turbine nozzle. The web plate includes a radial arm extending in a radial direction between an inner surface and an outer surface of the web plate. The radial arm, the inner surface, and the outer surface are disposed about an axial passage configured to facilitate a flow of combustion products from the transition piece to the turbine nozzle. The transition piece is disposed within a compressor discharge cavity configured to receive an oxidant. The radial arm includes an upstream face in fluid communication with the compressor discharge cavity. The radial arm also includes an arm passage that extends an axial length in an axial direction from the upstream face through at least an axial depth of the radial arm. The arm passage is configured to receive a portion of the oxidant through the upstream face.

### BACKGROUND

The subject matter disclosed herein relates to combustion turbine systems, and more specifically, to combustor and turbine sections of combustion turbine systems.

In a combustion turbine, fuel is combusted in a combustor section to form combustion products, which are directed to a turbine section. The turbine of the turbine section expands the combustion products to drive a load. The combustion products pass through a transition piece of the combustor section to a turbine nozzle of the turbine section. High temperatures and pressures of the oxidant may make sealing difficult. Unfortunately, leakages of combustion products between the combustor section and the turbine section may reduce the efficiency of the combustion turbine system.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In one embodiment, a system includes a web plate axially disposed between a transition piece and a turbine nozzle. The web plate includes a radial arm extending in a radial direction between an inner surface and an outer surface of the web plate. The radial arm, the inner surface, and the outer surface are disposed about an axial passage configured to facilitate a flow of combustion products from the transition piece to the turbine nozzle. The transition piece is disposed within a compressor discharge cavity configured to receive an oxidant. The radial arm includes an upstream face in fluid communication with the compressor discharge cavity. The radial arm also includes an arm passage that extends an axial length in an axial direction from the upstream face through at least an axial depth of the radial arm. The arm passage is configured to receive a portion of the oxidant through the upstream face.

In one embodiment, a system includes a web plate that includes a radial arm extending in a radial direction between an inner surface and an outer surface of the web plate. The radial arm is circumferentially disposed between a first axial passage and a second axial passage. The first axial passage extends in an axial direction through a first transition piece, the web plate, and a first turbine nozzle. The second axial passage extends through a second transition piece, the web plate, and a second turbine nozzle. The first axial passage and the second axial passage are configured to convey combustion products. The first transition piece and the second transition piece are disposed within a compressor discharge cavity configured to receive an oxidant. The radial arm includes a first arm passage configured to receive a first portion of the oxidant through a body of the radial arm. The radial arm also includes a second arm passage configured to receive a second portion of the oxidants through the body of the radial arm.

In one embodiment, a method includes directing a portion of an oxidant to an upstream face of a radial arm of a web plate. The web plate is disposed axially between a transition piece and a turbine nozzle. The method further includes cooling the radial arm of the web plate by directing the portion of the oxidant through one or more passages extending in an axial direction from the upstream face of the radial arm.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagram of an embodiment of a gas turbine system;

FIG. 2 is a diagram of an embodiment of a combustor section and a turbine section of the system of FIG. 1;

FIG. 3 is a perspective view of an embodiment of a transition piece of the combustion section and a turbine nozzle of the turbine section of the system of FIG. 2;

FIG. 4 is a side view of an embodiment of the transition piece, a web plate, and the turbine nozzle;

FIG. 5 is a perspective view of the system of FIG. 4, illustrating an embodiment of seals within the web plate;

FIG. 6 is a perspective view of a downstream face of the web plate;

FIG. 7 is a cutaway view of the transition piece and a radial arm of the web plate with an embodiment of a cooling system;

FIG. 8 is a cutaway view of the transition piece and a radial arm of the web plate with an embodiment of a cooling system; and

FIG. 9 is a flow chart depicting an embodiment of a method for cooling the radial arm of the web plate.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

Combustion products (e.g. exhaust gas) directed from a combustor to a turbine may pass through a transition piece and a turbine nozzle. The transition piece and the turbine nozzle may be separate components. Further, there may be additional structure (e.g., a web plate) disposed between the transition piece and the turbine nozzle. Forces from thermal effects (e.g., thermal expansion and contraction) and the velocity and pressure of the flow combustion products may act on the transition piece, the turbine nozzle, and the additional structure. Therefore, it is desirable to reduce the temperature (i.e., cool) the transition piece, the turbine nozzle, or the additional structure.

Accordingly, embodiments of the present subject matter generally relate to a system and method for a cooling system that cools one or more structures disposed between the transition piece and the turbine nozzle. Some embodiments include a web plate disposed between the transition piece and the turbine nozzle, where the web plate forms one or more seals. The web plate may be at least partially exposed to the thermal effects of the combustion products. The cooling system is employed to cool the web plate. The cooling system is fluidly coupled to a compressor discharge casing that receives an oxidant from a compressor. The cooling system also includes one or more passages in the web plate, the transition piece, or both. The oxidant may flow through the one or more passages. The flow of the oxidant through the one or more passages cools the surrounding structure.

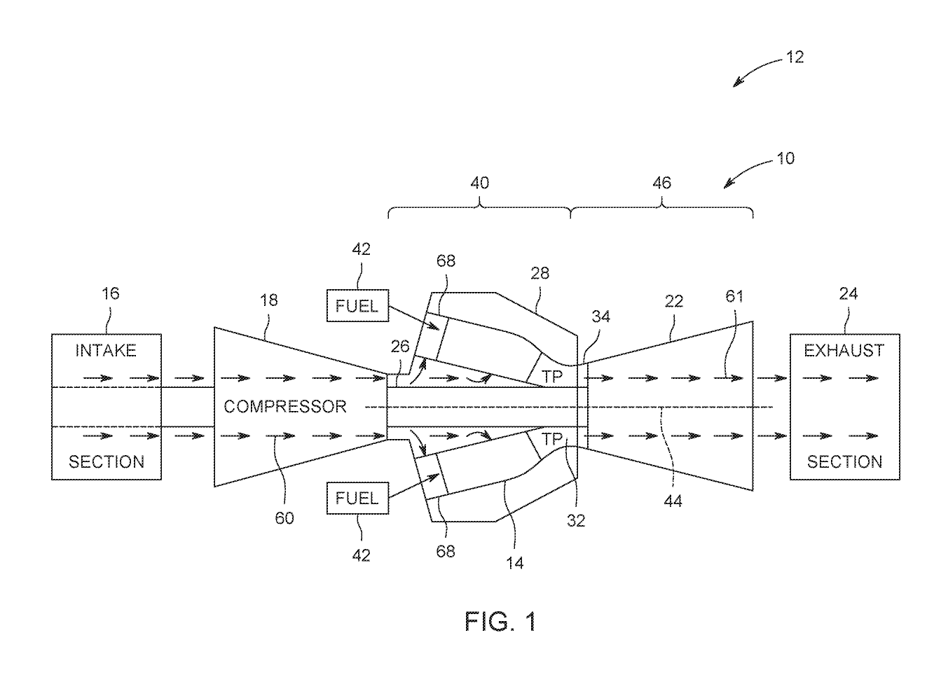

With the foregoing in mind, FIG. 1 is a block diagram of an example of a gas turbine system 10 that includes a gas turbine engine 12 having a combustor 14 and a turbine 22. In certain embodiments, the gas turbine system 10 may be all or part of a power generation system. In operation, the gas turbine system 10 may use liquid or gas fuel 42, such as natural gas and/or a hydrogen-rich synthetic gas, to run the gas turbine system 10. In FIG. 1, oxidant 60 (e.g. air) enters the system at an intake section 16. The compressor 18 compresses oxidant 60. The oxidant 60 may then flow into compressor discharge casing 28, which is a part of a combustor section 40. The combustor section 40 includes the compressor discharge casing 28, the combustor 14, and a transition piece 32.

Fuel nozzles 68 inject fuel 42 into the combustor 14. For example, one or more fuel nozzles 68 may inject a fuel-air mixture into the combustor 14 in a suitable ratio for desired combustion, emissions, fuel consumption, power output, and so forth. The oxidant 60 may mix with the fuel 42 in the fuel nozzles 68 or in the combustor 14. The combustion of the fuel 42 and the oxidant 60 may generate the hot pressurized exhaust gas (e.g., combustion products 61). The combustion products 61 pass into the turbine 22 via a passage of the transition piece 32 and a turbine nozzle 34. The combustor section 40 may have multiple combustors 14 and transition pieces 32. For example, the combustors 14 and transition pieces 32 may be disposed circumferentially about a turbine axis 44. Embodiments of the gas turbine engine 12 may include 1, 2, 3, 4, 5, 6, 7, 8, 9, 10, 11, or 12 or more combustors 14 and transition pieces 32.

A turbine section 46 includes the turbine 22 that receives the combustion products 61 through one or more turbine nozzles 34. Each turbine nozzle 34 may correspond to a respective transition piece 32 disposed about the axis 44. The combustion products 61 may drive one or more turbine blades within the turbine 22. For example, in operation, the combustion products 61 (e.g., the exhaust gas) flowing into and through the turbine 22 may flow against and between the turbine blades, thereby driving the turbine blades into rotation. The turbine blades are coupled to a shaft 26 of the gas turbine engine 12, which also rotates. In turn, the shaft 26 drives a load, such as an electrical generator in a power plant. The shaft 26 lies along the turbine axis 44 about which turbine 22 rotates. The combustion products 61 exit the turbine 22 through an exhaust section 24.

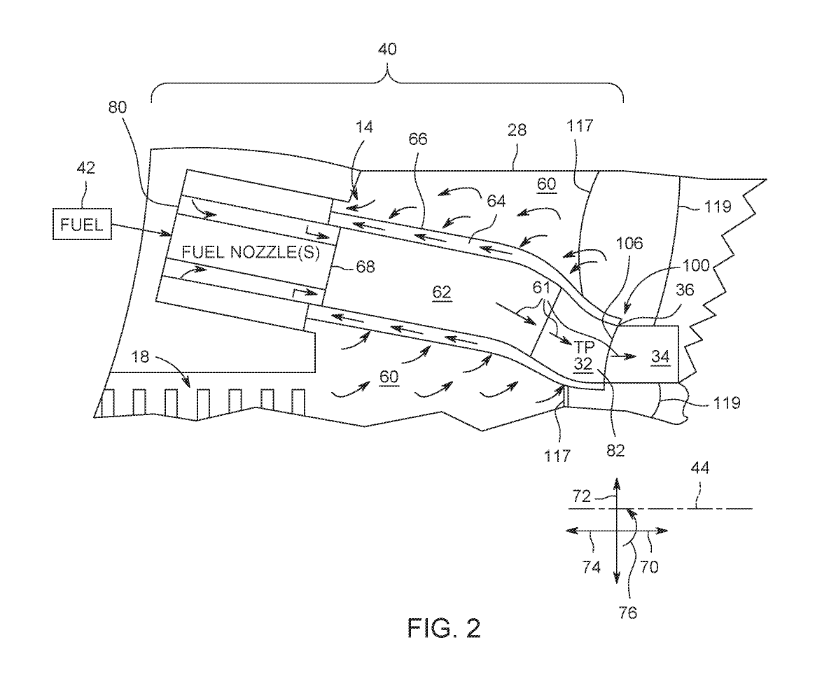

FIG. 2 is a diagram of an embodiment of the combustor section 40 that includes various features described in FIG. 1. As discussed herein, a downstream direction is indicated by arrow 70, a radial direction is indicated by arrow 72, an upstream direction is indicated by arrow 74, and a circumferential direction is indicated by arrow 76. As described in FIG. 1, oxidant 60 exits from the compressor 18 and enters into the compressor discharge casing 28. The oxidant 60 may include air, oxygen, oxygen-enriched air, oxygen-reduced air, or oxygen nitrogen mixtures.

The oxidant 60 may pass from the compressor discharge casing 28 into a sleeve passage 64, which is formed by the cavity separating a combustion chamber 62 and a sleeve 66. In some embodiments, the oxidant 60 may flow directly from the compressor discharge casing 28 into a combustion head 80. The flow of oxidant 60 through the sleeve passage 64 may cool the combustion chamber 62, the transition piece 32, and/or a web plate 36. That is, the oxidant 60 may flow in the upstream direction 74 through the sleeve passage 64 toward the combustion head 80, or in the downstream direction 70 toward the web plate 36 and turbine nozzle 34. It should be appreciated that the combustion chamber 62 may be part of a single piece that includes the transition piece 32. Alternatively, the combustion chamber 62 and the transition piece 32 may be separate from one another. The web plate 36 is part of a system for sealing between the transition piece 32 and the turbine nozzle 34. The web plate 36 is described in greater detail below. In some embodiments, a portion of the oxidant 60 flows in the downstream direction 70 toward the web plate 36 to cool radial arms, the inner surfaces of the web plate 36, the outer surfaces of the web plate 36, or any combination thereof of the web plate 36. The oxidant 60 directed toward the web plate 36 may be discharged downstream with combustion products 61, directed upstream toward the combustion head 80, or any combination thereof. After flowing in the upstream direction 74 through the sleeve passage 64, the oxidant 60 may flow into the combustion head 80. From there, the oxidant 60 flows into the combustion chamber 62. In some embodiments, portions of the oxidant 60 may flow into the combustion chamber 62 from the sleeve passage 64 as a diluent and/or cooling flow.

Fuel 42 is injected into the combustion chamber 62 through a fuel nozzle 68. In the illustrated example, the oxidant 60 mixes with the fuel 42 inside the combustion chamber 62; however, in alternative embodiments, the fuel 42 and the oxidant 60 may mix at any suitable location, including inside the fuel nozzle 68. The mixture of the oxidant 60 and the fuel 42 then combusts in the combustion chamber 62. The combustion products 61 flow in the downstream direction 70 through a passage 82 of the transition piece 32, the web plate 36, and the turbine nozzle 34. It should be appreciated that the gas turbine engine 12 could include a plurality of combustors 14, transition pieces 32, and turbine nozzles 34 disposed in the circumferential direction 76 about the turbine axis 44. Each combustor 14 may include similar structure (e.g., fuel nozzle 68, flow sleeve 66) as described above. A first support 117 may support or hold in place one or more of the transition pieces 32. A second support 119 may support or hold in place one or more of the turbine nozzles 34.

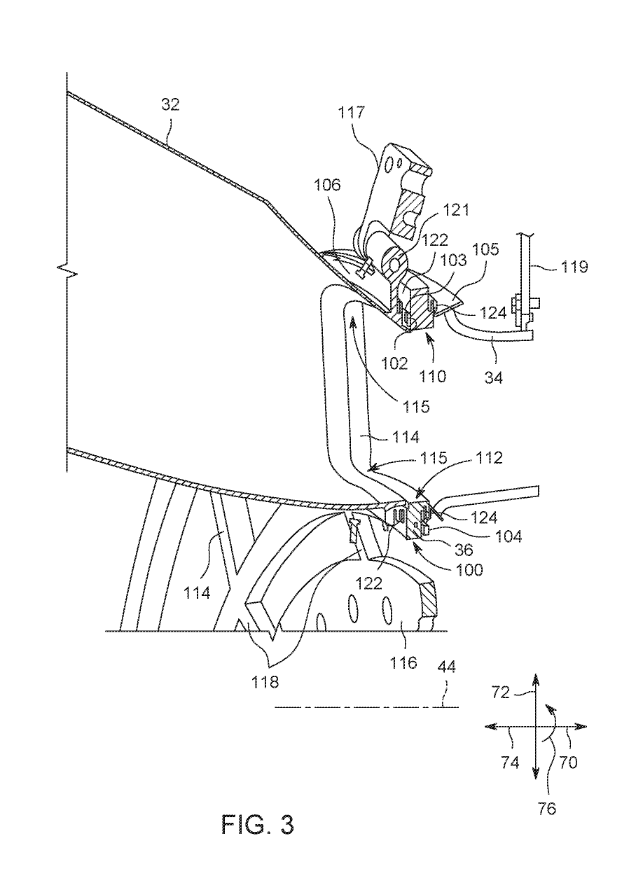

FIG. 3 is a diagram of an embodiment of a seal system 100 between the transition piece 32 and the turbine nozzle 34 that reduces or eliminates the leakage of the oxidant 60 into the passage 82. As discussed previously, the combustion products 61 flow in a downstream direction 70 through the passage 82 of the transition piece 32 and the turbine nozzle 34. The seal system 100 is disposed between the transition piece 32 and the turbine nozzle 34. In some embodiments, the web plate 36, a first sealing element 102, a second sealing element 104, and an aft frame 106 form the seal system 100.

The web plate 36 is disposed between the transition piece 32 and the turbine nozzle 34. With the web plate 36, there are two interfaces between the transition piece 32 and the turbine nozzle 34. The first interface is between the transition piece 32 and the web plate 36 and the second interface is between the web plate 36 and the turbine nozzle 34. The first sealing element 102 is utilized to form a first seal 103 at the interface between the transition piece 32 and the web plate 36. In some embodiments, the transition piece 32 may include the aft frame 106. The aft frame 106 is disposed between the transition piece 32 and the web plate 36. The aft frame 106 may be integral with the transition piece 32 or coupled by a fastener (e.g. a bolt, a pin, a weld) to the transition piece 32. In embodiments including the aft frame 106, the first sealing element 102 forms the first seal 103 at the interface between the aft frame 106 and the web plate 36. The first sealing element 102 extends in the circumferential direction 76 along the web plate 36 and may extend continuously about the passage 82, or any fraction about the passage 82, including 25 percent, 50 percent, 75 percent, or 100 percent. The first sealing element 102 may be disposed on an upstream face 122 of the web plate 36 between the transition piece 32 and the web plate 36. The upstream face 122 may be a part of the radially outer surface 110, the radially inner surface 112, the radial arms 114, or any combination thereof. One or more radial arms 114 of the web plate 36 extend in the radial direction 72 between a radially outer surface 110 and a radially inner surface 112. In some embodiments, the first sealing element 102 may extend continuously along the web plate 36 around corners 115 of the passage 82 from the radially outer surface 110 to the radial arm 114, continuously along the web plate 36 from the radially inner surface 112 to the radial arm 114, or any combination thereof. Embodiments of a continuous first sealing element 102 around the corners 115 of the passage 82 may reduce or eliminate leakage of oxidant 60 at the first seal 103. The first sealing element 102 may be along only the radially inner surface 112, only the radially outer surface 110, only the radial arm 114, or along any combination of the radially inner surface 112, the radially outer surface 110, and the one or more radial arms 114 about the passage 82.

The second sealing element 104 is disposed at the interface between the web plate 36 and the turbine nozzle 34 to form a second seal 105. The second sealing element 104 extends in the circumferential direction 76 along the web plate 36 and may extend continuously about at least one of the turbine axis 44 or the passage 82 or any fraction about the at least one of the turbine axis 44 or the passage 82, including 25 percent, 50 percent, 75 percent, or 100 percent. The second sealing element 104 may be disposed on a downstream face 124 of the web plate 36 between the web plate 36 and the turbine nozzle 34. The downstream face 124 may be a part of the radially outer surface 110, the radially inner surface 112, the radial arms 114, or any combination thereof. In some embodiments, the second sealing element may extend continuously along the web plate 36 around corners 115 of the passage 82 from the radially outer surface 110 to the radial arm 114, continuously along the web plate 36 from the radially inner surface 112 to the radial arm 114, or any combination thereof. Embodiments of a continuous second sealing element 104 around the corners 115 of the passage 82 may reduce or eliminate leakage of oxidant 60 at the second seal 105. The second sealing element 104 may be along only the radially inner surface 112, only the radially outer surface 110, only the radial arm 114, or along any combination of the radially inner surface 112, the radially outer surface 110, and the one or more radial arms 114 about the passage 82.

The web plate 36 includes the radially inner surface 112, the radially outer surface 110, and at least one radial arm 114 extending in the radial direction 72 from the radially inner surface 112 to the radially outer surface 110. Accordingly, the radial arm 114 couples the radially inner surface 112 to the radially outer surface 110. The radially inner surface 112, the radially outer surface 110, and two opposing radial arms 114 may form the passage 82. The passage 82 may include multiple passages 82 that are circumferentially distributed about the turbine axis 44.

FIG. 3 depicts the web plate 36 extending in a circumferential direction 76 about the turbine axis 44. Some embodiments of the web plate 36 may extend circumferentially around 25 percent, 50 percent, 75 percent, or 100 percent of the turbine axis 44. Some embodiments may include multiple web plates 36 disposed circumferentially about the turbine axis 44 and each web plate 36 may extend in the circumferential direction 76 around 10 percent, 20 percent, 30 percent, 40 percent, or 50 percent of the turbine axis 44. Embodiments that include multiple web plates may each include multiple passages 82. It should be noted that each passage 82 may correspond to a respective transition piece 32 and a respective turbine nozzle 34. In some embodiments, each passage 82 could fluidly couple one transition piece 32 to multiple turbine nozzles 34. Alternatively, the passage 82 could fluidly couple multiple transition pieces 32 to one turbine nozzle 34. Web plates 36 that extend in the circumferential direction 76 around a portion of the turbine axis 44 may couple to a corresponding portion of the total number of transition pieces 32 and turbine nozzles 34 the gas turbine engine 12.

FIG. 3 also depicts the web plate 36 coupled to a web plate support 116. The web plate support 116 extends from the web plate 36 in a radial direction 72 towards a central section of the gas turbine engine 12. The web plate support 116 may couple to additional structure (e.g. bearings, the compressor discharge casing 28, an inner turbine shell, an inner support ring) of the gas turbine engine 12.

It should be noted that the web plate support 116 may extend in any suitable direction, including in the radial direction 72 away from the center of the gas turbine engine 12 or at any angle in relation to the radial direction (e.g. 10, 20, 30, 40, 50, or 60 degrees). The web plate support 116 may couple to any suitable structure, including the compressor discharge casing 28, the first support 117, the second support 119, an inner turbine shell, or an inner support ring. Web plate 36 may be coupled to web plate support 116 in any suitable manner, including welding or bolting the web plate 36 and the web plate support 116 to one another. Alternatively, the web plate 36 and the web plate support 116 may be integral with one another. Further, web plate support 116 may be rigidly coupled to web plate 36 by arms 118 that extend from the web plate 36 to the web plate support 116. Alternatively, the arms 118 may extend from the web plate support 116 to the web plate 36. The web plate support 116 could include any number of arms 118, including 1, 2, 3, 4, 5, 6, or more. Further, the web plate support 116 extends in the circumferential direction 76 about the turbine axis 44 and may extend in the circumferential direction 76 to any fraction about the turbine axis 44, including 25 percent, 50 percent, 75 percent, or 100 percent. For example, the web plate support 116 may be configured to support 1, 2, 3, 4, 5, or 6 or more web plates 36 disposed about the turbine axis 44.

The web plate support 116 may also support the transition piece 32 and/or the turbine nozzle 34. However, it should be appreciated that the transition piece 32 may couple to the first support 117. It should be appreciated that the turbine nozzle 34 may couple to the second support 119. The first support 117 and the second support 119 may include structure similar to the web plate support 116, with a member extending circumferentially and arms coupling the member. Alternative embodiments of the structure could include rigid arms extending towards other members of the gas turbine engine 12. The first support 117 and the second support 119 may extend towards and couple to other members of the gas turbine engine 12, including the compressor discharge casing 28, additional structure (e.g. bearings, the compressor discharge casing 28, an inner support ring, an inner turbine shell) toward the central section of the gas turbine engine 12, or the web plate support 116.

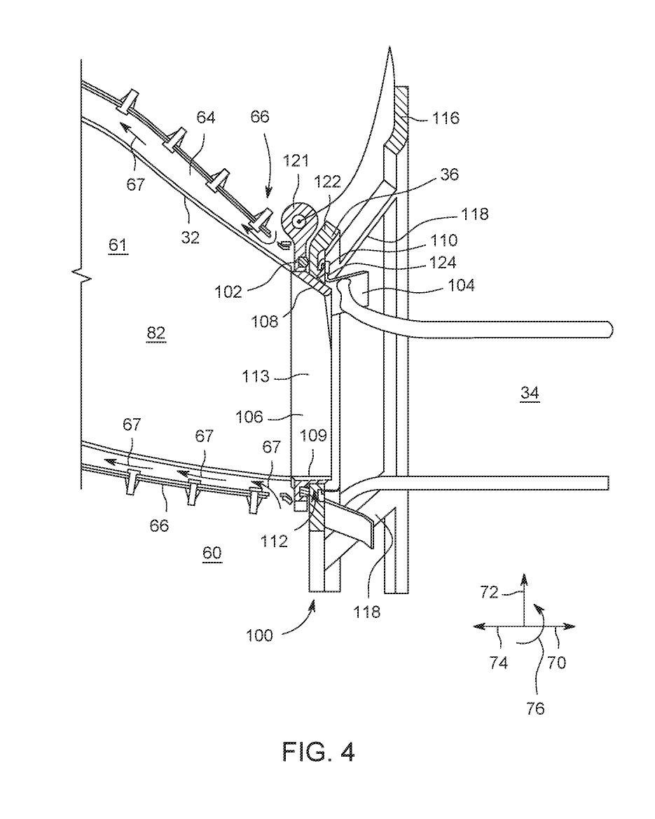

FIG. 4 is a side view of the seal system 100. The sleeve passage 64 is shown disposed between the transition piece 32 and the sleeve 66. The sleeve passage 64 allows oxidant 60 to flow in the upstream direction 74 along a path 67. The path 67 is the path oxidant 60 follows to travel from the compressor discharge casing to the combustion head 80. The oxidant 60 flowing on the path 67 begins in the compressor discharge casing. From there, the oxidant 60 flows along the path to the sleeve passage 64 and into the combustion head 80. While flowing along the path 67, portions of the oxidant 60 may come into contact with a surface of the transition piece 32, the aft frame 106 and/or, in some embodiments, the web plate 36. Combustion products 61 may also come into contact with a different surface of the transition piece 32, the aft frame 106, and the web plate 36. Because the oxidant 60 tends to be at a lower temperature than the combustion products 61, the oxidant 60 may provide cooling to the transition piece 32, the aft frame 106, the web plate 36, or any combination thereof.

In the embodiment of FIG. 4, the aft frame 106 includes an outer flange 108 that is radially disposed between the radially outer surface 110 and the flow of combustion products 61 through the passage 82. Aft frame 106 includes an inner flange 109 that is disposed between the radially inner surface 112 and the flow of combustion products 61 through the passage 82. Aft frame 106 also includes a radial flange 113 that is disposed between the radial arm 114 and the flow of combustion products 61 through the passage 82. Although in alternative configurations, aft frame 106 may include the outer flange 108, the inner flange 109, the radial flange 113, or any combination thereof. The outer flange 108, the inner flange 109, and the radial flange 113 of the aft frame 106 may protect the web plate 36 from the heat of the combustion products 61. In some embodiments, the outer flange 108, the inner flange 109, and the radial flange 113 may be part of or integral with the transition piece 32.

FIG. 4 illustrates the first sealing element 102 with a rope seal, but it should be appreciated that the first sealing element 102 may include any suitable seal, including a bellow seal, a w-seal, a hula seal, or a spline seal. FIG. 4 illustrates the second sealing element 104 with a cloth seal. However, the second sealing element 104 may include any suitable seal, including a laminated cloth seal or a leaf seal. The first sealing element 102 is in the upstream direction 74 from the web plate 36, and the second sealing element 104 is in the downstream direction 70 from the web plate 36.

In the embodiment of FIG. 4, the web plate support 116 extends outwardly in the radial direction 72. The web plate support 116 may also extend in the circumferential direction 76 about the turbine axis 44 and may extend circumferentially to any fraction about the turbine axis 44, including 25 percent, 50 percent, 75 percent, or 100 percent. The web plate support 116 includes arms 118 that extend from the web plate support 116 to the web plate 36 and the arms 118 couple to the web plate 36. The web plate support 116 may include any number of arms, including 1, 2, 3, 4, 5, or 6 or more. The web plate support 116 couples to the compressor discharge casing 28. However, as depicted in FIG. 3, web plate support 116 may couple to any suitable location, such as an inner section of the compressor discharge casing 28, an inner turbine shell, or an inner support ring.

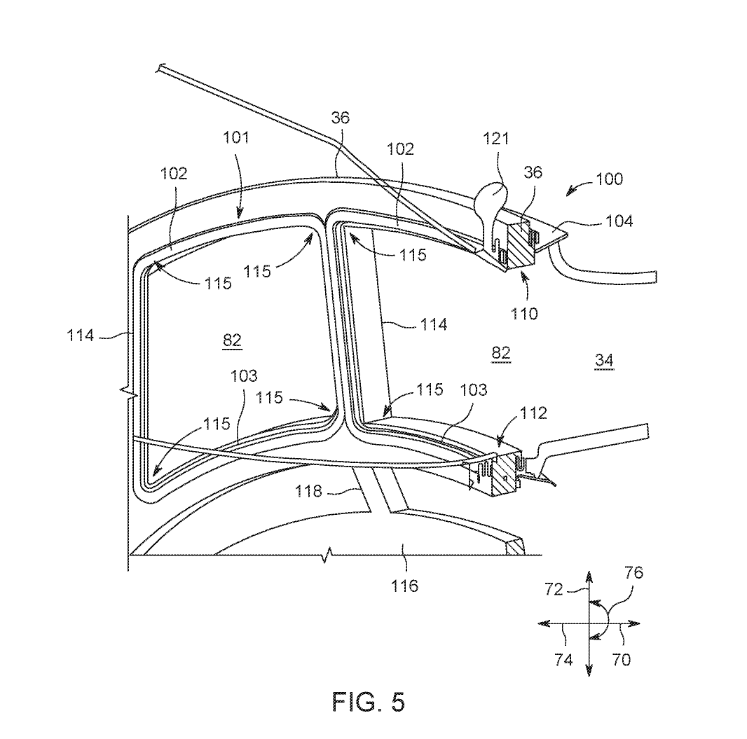

FIG. 5 is a perspective view detailing the structure of the first sealing element 102 of the seal system 100. The seal system 100 may include the first sealing element 102 and the second sealing element 104. The first sealing element 102 forms the first seal 103 between the web plate 36 and the transition piece 32. The second sealing element 104 forms the second seal 105 between the web plate 36 and the turbine nozzle 34.

The first sealing element 102 may be a continuous seal around a section 101 of the web plate 36 that includes the radially inner surface 112, the radially outer surface 110, and two radial arms 114. The section 101 forms the passage 82. It should be noted that the web plate 36 may include only one section 101 or multiple sections 101. For example, the web plate could have 1, 2, 3, 4, 5, or 6 or more sections 101. The first sealing element 102 may be disposed along only a portion of the section 101. For example, the first sealing element 102 may be disposed along the radially inner surface 112, the radially outer surface 110, one radial arm 114, two radial arms 114, or any combination thereof. Further, each section 101 of the web plate 36 may include a different first sealing element 102. The first sealing element 102 may include multiple first sealing elements 102 disposed along any combination of the radially inner surface 112, the radially outer surface 110, and the radial arms 114. For example, each of the multiple first sealing elements 102 may extend continuously along the web plate 36 around corners 115 of the passage 82 from the radially outer surface 110 to the radial arm 114, continuously along the web plate 36 from the radially inner surface 112 to the radial arm 114, or any combination thereof. In the embodiment of FIG. 5, the first sealing element 102 may be continuous and extend in a circumferential direction 76 to any fraction about the section 101, including 25 percent, 50 percent, 75 percent, or 100 percent.

The second sealing element 104 may be a continuous seal around the section 101. The second sealing element 104 may be disposed along only a portion of the section 101. Further, the second sealing element 104 may be disposed along only a single section 101 or any suitable number of sections 101, including 1, 2, 3, 4, 5, 6, or more. The second sealing element 104 may be disposed along only a portion of the section 101. For example, the second sealing element 104 may be disposed along the radially inner surface 112, the radially outer surface 110, one radial arm 114, two radial arms 114, or any combination thereof. Further, each section 101 of the web plate 36 may include a different second sealing element 104. The second sealing element 104 may include multiple second sealing elements 104 disposed along any combination of the radially inner surface 112, the radially outer surface 110, and the radial arms 114. For example, each of the multiple second sealing elements 104 may extend continuously along the web plate 36 around corners 115 of the passage 82 from the radially outer surface 110 to the radial arm 114, continuously along the web plate 36 from the radially inner surface 112 to the radial arm 114, or any combination thereof. In the embodiment of FIG. 5, the second sealing element 104 may be continuous and extend in a circumferential direction 76 to any fraction about the section 101, including 25 percent, 50 percent, 75 percent, or 100 percent.

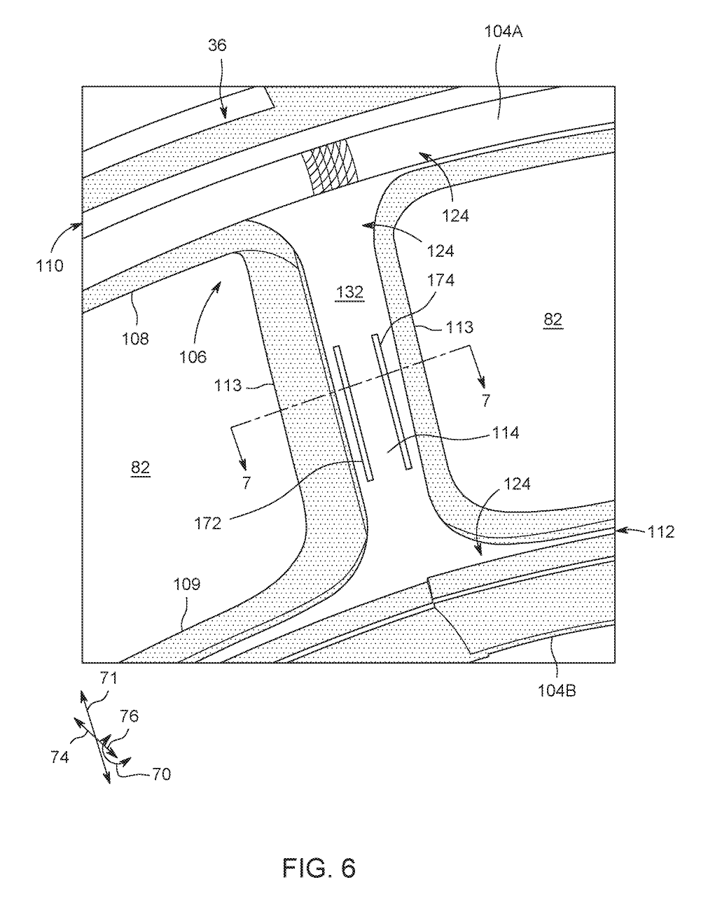

FIG. 6 is a perspective view of the downstream face 124 of the web plate 36. As previously discussed, the web plate 36 includes the radially outer surface 110, the radially inner surface 112, and the radial arm 114. Further, the radially outer surface 110, the radially inner surface 112, and the radial arm 114 form the passages 82 to direct combustion products 61 from the transition piece 32 to the turbine nozzle 34. In the embodiment of FIG. 6, the second sealing element 104 is two separate second sealing elements 104A and 104B. The second sealing element 104A couples to the radially outer surface 110 and extends in the circumferential direction 76 along the radially outer surface 110. The second sealing element 104B couples to the radially inner surface 112 and extends in the circumferential direction 76 along the radially outer surface 112. It should be appreciated that each of the second sealing elements 104A and 104B may extend to any fraction of the web plate 36 including 25 percent, 50 percent, 75 percent, or 100 percent. Further, each second sealing element 104A and 104B may include multiple second sealing elements (i.e., 1, 2, 3, 4, 5, or 6, or more).

As previously discussed, the aft frame 106 may be coupled to the web plate 36. In the embodiment of FIG. 6, the aft frame 106 includes the outer flange 108, the inner flange 109, and the radial flange 113. Further, an aft frame 106 may be included for each passage 82. The outer flange 108 is disposed along the outer radial surface 110, the inner flange 109 is disposed along the radially inner surface 112, and the radial flange 113 is disposed along the radial arm 114. The outer flange 108, the inner flange 109, and the radial flange 113 are disposed between the web plate 36 and the flow of combustion products 61 through the passage 82. In some embodiments, the outer flange 108 may interface with the second sealing element 104A, and the inner flange 109 may interface with second sealing element 104B. In other embodiments, the outer flange 108 does not interface with the second sealing element 104A, and the inner flange 109 does not interface with the second sealing element 104B. The combination of the outer flange 108 and the second sealing element 104A may partially or fully isolate the radially outer surface 110 from exposure to the flow of combustion products 61. Likewise, the combination of the inner flange 109 and the second sealing element 104B may partially or fully isolate the radially inner surface 112 from exposure to the flow of combustion products 61. Isolation of the surfaces 110, 112 from the flow of combustion products 61 may reduce the exposure of the surfaces 110, 112 to the high temperatures of the combustion products 61.

The combustion products 61 flows through passages 82 on either side of the radial arm 114. As discussed previously, each passage 82 may include a corresponding aft frame 106. Further, the aft frame 106 may include the radial flange 113. Each radial flange 113 is disposed between a surface of the radial arm 114 and the flow of combustion products 61 through the passage 82. FIG. 4 depicts two passages 82 and two corresponding aft frames 106 with a single radial arm 114 disposed between the two passages 82. Each of the two aft frames 106 includes a radial flange 113 disposed between a surface of the radial arm 114 and the flow of combustion products 61. In the embodiment of FIG. 6, the two radial flanges 113 do not interface with one another, thereby at least partially exposing the downstream face 132 of the radial arm 114 to the flow of combustion products 61, forming a gap between them. Alternative embodiments may include two radial flanges 113 that do interface with one another, thereby partially or fully isolating the downstream face 132 of the radial arm 114 from the flow of combustion products. As previously discussed, the combustion products 61 are at a high temperature. Embodiments of the web plate 36 and radial arm 114 discussed in detail below may provide cooling to components (e.g., radial arm 114, aft frame 106) or surfaces (e.g., of the radial arm 114 or aft frame 106) that are near to or exposed to the combustion products 61. For example, the radial arm 114 may include a first arm passage 172 and a second arm passage 174 that allow a cooling fluid to pass through the radial arm 114. The arm passages 172, 174 are part of a cooling system and are described in detail below.

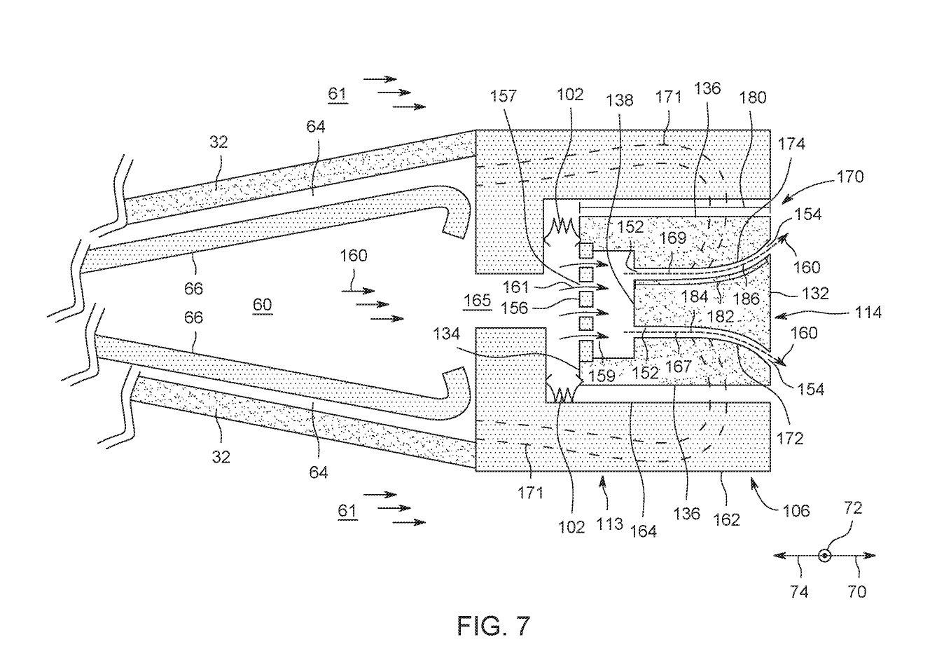

FIG. 7 is a cutaway view of the radial arm 114, two aft frames 106, two transition pieces 32, and a cooling system 170 taken along line 7-7 of FIG. 6. FIG. 7 includes two opposing transition pieces 32, each with a corresponding sleeve 66. Each transition piece 32 is coupled to a corresponding aft frame 106. Although, as previously discussed, the aft frame 106 may be part of the transition piece 32. In the embodiment of FIG. 7, each aft frame 106 includes the radial sleeve 113. The radial sleeve 113 is disposed between a circumferential surface 136 of the radial arm 114 and the flow of combustion products 61. Despite the radial sleeve 113 being disposed between the circumferential surface 136 and the flow of combustion products 61, some combustion products 61 may interact with the circumferential surface 136 in the area between the circumferential surface 136 and a circumferential aft frame surface 164. As previously discussed, the first sealing elements 102 are disposed along the upstream surface 134 of the radial arm 114. The first sealing elements 102 may be continuous along the length of the radial arm 114 in the radial direction 72.

The radial arm 114 includes a cooling system 170 that may cool the radial arm 114. It should be appreciated that although the depicted embodiment includes the cooling system 170 in the radial arm 114, the cooling system 170 may also be utilized in the radially outer surface 110 or the radially inner surface 112. The cooling system 170 allows the oxidant 60 to flow through the radial arm 114. In the embodiment of FIG. 7, the cooling system 170 includes an impingement plate 156, a first arm passage 172, and a second arm passage 172. The impingement plate 156 has a number of impingement ports 157. The impingement plate 156 may include any suitable number of impingement ports 157, including 1, 2, 3, 4, 5, 10, 20, 50, 100, or more. The impingement plate 156 extends in a radial direction and may extend to any suitable length of the radial arm 114, including 10 percent, 25 percent, 50 percent, or 100 percent. In the embodiment of FIG. 7, the impingement plate 156 is disposed along the upstream surface 134 of the radial arm 114. However, in alternative embodiments, the impingement plate 156 may be disposed further upstream or downstream from the upstream surface 134 of the radial arm 114. Because the impingement plate 156 is disposed at the upstream surface 134, the radial arm 114 also includes an impinged surface 138 that is downstream of the upstream surface 134, but upstream of the downstream surface 132. In alternative embodiments that do not include the impingement plate 156 or in embodiments that include an impingement plate 156 upstream of the upstream surface 134, the upstream surface 134 and the impinged surface 138 may be the same surface.

As previously discussed, the oxidant 60 is at a lower temperature than the combustion products 61. Therefore, any component or surface that is exposed to the combustion products 61 or near the combustion products 61 may be cooled by the oxidant 60. As previously discussed, the oxidant 60 flows into the compressor discharge casing 28 and between the transition pieces 32. Each transition piece may be shrouded in a sleeve 66. As depicted in FIG. 7, the oxidant 60 flows into the area between the two sleeves 66. As previously discussed, the oxidant 60 may flow in the sleeve passage 64 between the sleeve 66 and the transition piece 32.

In the embodiment of FIG. 7, a portion of the oxidant 60 may also flow along a cooling path 160. The oxidant 60 flowing on the cooling path 160 flows from the area between the transition pieces 32 through a gap 165 between the two aft frames 106. After flowing through the gap 165, the oxidant 60 flows through the impingement ports 157 of the impingement plate 156 into an impingement region 159. The oxidant 60 flowing through the impingement ports 157 creates an impingement flow 161 through each of the impingement ports 157. The impingement flow 161 creates a higher rate of heat transfer between the oxidant 60 and the impinged surface 138 as compared to oxidant 60 interaction with the upstream surface 134 without the impingement plate 156. The oxidant 60 flows from the impingement region 159 into the first arm passage 172 and the second arm passage 172 at respective cooling passage inlets 152. Then, a first portion 184 of the oxidant 60 flows through the first arm passage 172 and a second portion 186 of the oxidant 60 flows through the second arm passage 172. The respective portions of the oxidant 60 pass an axial length 182 through the first arm passage 172 and the second arm passage 174. The axial length 182 is greater than or equal to an axial depth 180 of the radial arm. That is, the arm passages 172, 174 may be angled relative to the downstream direction 70, curved within the radial arm 114, or any combination thereof. The axial depth 180 is the distance from the upstream face 134 to the downstream face 132. The portions of the oxidant 60 exit the first arm passage 172 and the second arm passage 172 at respective arm passage outlets 154, which are disposed along the downstream face 132 of the radial arm 114. In some embodiments, the arm passage outlet 154 may be disposed on the circumferential surface 136. That is, the oxidant 60 may flow through cooling passages 171 from the upstream face 134 of the radial arm 114 to one of the circumferential faces 136 of the radial arm 114. Further, in some embodiments, the cooling passage 171 may extend through the aft frame 106, allowing the oxidant 60 to flow through the aft frame 106 to the sleeve passage 64. Once the oxidant 60 has exited the arm passage outlet 154, the oxidant 60 flows into the turbine nozzle 34 and mixes with the combustion products 61.

Although the embodiment of FIG. 7 includes two arm passages, it should be appreciated that the cooling system 170 may include any suitable number of arm passages, including 1, 2, 3, 4, 5, 10, 20, 50, 100, or more. Further, the cooling passages may be disposed in any orientation or pattern along the radial arm 114. The cooling passages may extend along the radial axis 72 to any suitable radial length of the radial arm 114, including 10 percent, 25 percent, 50 percent, or 100 percent of the length of the radial arm 114. In the depicted configuration, the cooling passages are slightly curved towards the circumferential face 136. In alternative embodiments, the cooling passages may include any suitable shape, including an approximately 90 degree turn towards the circumferential surface 136 and another approximately 90 degree turn towards the downstream face 132.

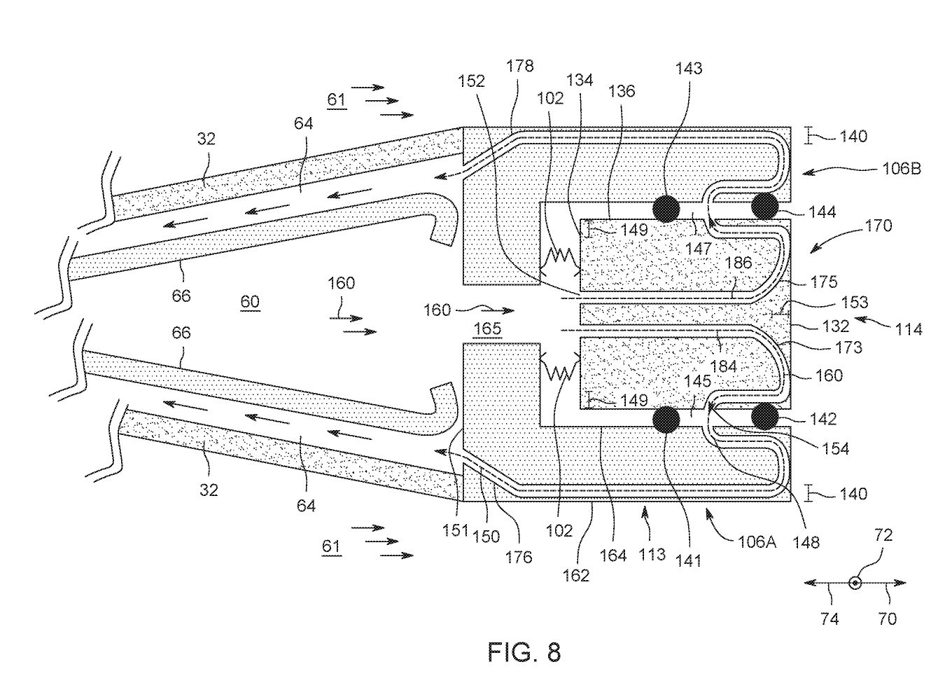

FIG. 8 is a cutaway view of the radial arm 114, two aft frames 106, two transition pieces 32, and an alternative embodiment of the cooling system 170 of FIG. 7. FIG. 8 again depicts two transition pieces 32 and two corresponding sleeves 66 with the oxidant 60 from the compressor discharge casing 28 filling the space between the two sleeves 66. Each of the transition pieces 32 is coupled to a corresponding aft frame 106A and 106B. Each of the first aft frame 106A and the second aft frame 106B include the radial flange 113. First sealing elements 102 are disposed along the upstream face 134 of the radial arm 114.

The embodiment of FIG. 8 of the cooling system 170 includes the first arm passage 173, the second arm passage 175, a first aft frame cooling passage 176, a second aft frame cooling passage 178, a first sealing member 141, a second sealing member 142, a third sealing member 143, and a fourth sealing member 144. The first sealing member 141 and the second sealing member 142 form a first chamber 145 between the circumferential aft frame surface 164 of aft frame 106A and the circumferential surface 136 of the radial arm 114. The third sealing member 143 and the fourth sealing member 144 form a second chamber 147 between the circumferential aft frame surface 164 of aft frame 106B and the circumferential surface 136 of the radial arm 114. The thickness (i.e., the distance between the circumferential surfaces 136, 164) of the first chamber 145 and the second chamber 147 may be any suitable thickness, including 0.2 mm, 0.5 mm, 1 mm, 2 mm, 3 mm, or more. Further, the thickness of the first chamber 145 and the second chamber 147 may or may not be equal to each other. It may be appreciated that the thicknesses of the first chamber 145 and the second chamber 147 illustrated in FIGS. 7 and 8 are enlarged for clarity of description, and are not to scale.

Each of the arm passages 173 and 175 include the arm passage inlet 152 disposed on the upstream face 134 of the radial arm 114. Each of the arm passages 173 and 175 also includes the arm passage outlet 154 disposed on opposing circumferential surfaces 136 of the radial arm 114. The first sealing member 141 is disposed between the first aft frame 106A and the radial arm 114 upstream of the first arm passage outlet 154 relative to the combustion products 61. The second sealing member 142 is disposed between the first aft frame 106A and the radial arm 114 downstream of the first arm passage outlet 154 relative to the combustion products 61. The third sealing member 143 is disposed between the second aft frame 106B and the radial arm 114 upstream of the second arm passage outlet 154 relative to the combustion products 61. The fourth sealing member 144 is disposed between the second aft frame 106B and the radial arm 114 downstream of the first arm passage outlet 154 relative to the combustion products 61.

The four sealing members may include any suitable seal, including a rope seal, a bellow seal, a w-seal or any combination thereof. Each of the first aft frame cooling passage 176 and the second aft frame cooling passage 178 includes an aft frame inlet 148 and an aft frame outlet 150. Further, each of the first aft frame cooling passage 176 and the second aft frame cooling passage 178 extend along a skin region 140 of the aft frame 106. The skin region 140 extends 5 percent to 25 percent of a circumferential depth of the aft frame 106 from a combustion product surface 162 of the aft frame 106. Other surfaces may also have a skin region. For example, the radial arm 114 may have a skin region 153 that extends from the downstream surface 153. The radial arm may have another skin region 149 that extends from the circumferential surface 136. Each of the skin regions (e.g., 140, 149, and 153) may extend 5 to 25 percent of the respective depths.

As previously discussed, the oxidant 60 may flow along the cooling path 160. The oxidant 60 flows from the area between the sleeves 66 through the gap 165 between the first aft frame 106A and the second aft frame 106B. The oxidant 60 then enters into the first arm passage 173 and the second arm passage 175 at the arm passage inlets 152. The oxidant 60 then flows through the first arm passage 173 and the second arm passage 175 downstream towards the downstream surface 132 of the radial arm 114. A first portion 184 of the oxidant 60 continues through the first arm passage 173 and a second portion of the arm passage 186 continues through the second arm passage 175. The oxidant 60 flowing through the first arm passage 173 and the second arm passage 175 cools the radial arm 114. Then, the oxidant 60 exits through the arm passage outlets 154 along the circumferential surface 136 of the radial arm 114. The oxidant 60 enters the first aft frame cooling passage 176 and the second aft frame cooling passage 178 at aft frame inlets 148. In some embodiments, the outlets 154 may abut the aft frame inlets 148, thereby allowing the oxidant 60 to flow directly from the arm passages 173, 175 into the aft frame cooling passages 176, 178. The oxidant 60 may also flow directly from the arm passages 173, 175 into the aft frame cooling passages 176, 178 when the sealing members are disposed between the radial arm 114 and the aft frame. The oxidant 60 then flows in the upstream direction 74, cooling the aft frames 106A and 106B as it flows through the first aft frame cooling passage 176 and the second aft frame cooling passage 178. Then, the oxidant 60 exits the first aft frame cooling passage 176 and the second aft frame cooling passage 178 at the outlets 150, where the oxidant 60 enters the sleeve passage 64.

Specifically, in the embodiment of FIG. 8, once the oxidant 60 enters the first arm passage 173 and the second arm passage 175, the oxidant 60 continues through first arm passage 173 and the second arm passage 175 from the upstream face 134 to the downstream face 132. The first arm passage 173 and the second arm passage 175 extend along the skin region 153 of the downstream surface 132. The first arm passage 173 and the second arm passage 175 then curve back in the upstream direction 74 and extend along the skin region 149 of the circumferential surface 136 before exiting the first arm passage 173 and the second arm passage 175 at outlets 154 disposed on opposing circumferential surfaces 136 of the radial arm 114. Then, the oxidant 60 enters the first aft frame cooling passage 176 and the second aft frame cooling passage 178 at the inlets 148, which are disposed on the circumferential aft frame surface 164 of the aft frames 106A and 106B. The first aft frame cooling passage 176 and the second aft frame cooling passage 178 then curve in the downstream direction 70 before curving towards the combustion product surface 162. The first aft frame cooling passage 176 and the second aft frame cooling passage 178 then curve in an upstream direction 74 and extend along the skin region 140 of the aft frames 106A and 106B, respectively. The oxidant 60 then exits the first aft frame cooling passage 176 and the second aft frame cooling passage 178 at outlets 150 disposed on the upstream face 151 of the aft frame. The outlets 150 fluidly couple the first aft frame cooling passage 176 and the second aft frame cooling passage 178 to the sleeve passage 64. Once the oxidant 60 exits the outlets 150, the oxidant flows through the sleeve passages 64 in the upstream direction 74, as previously discussed. The sleeve passages 64 extend between the sleeve 66 and the transition piece 32.

The arm passages 172, 173, 174, 175, 176, and 178 may be formed in any suitable manner. In some embodiments, the cooling passages may be formed by drilling, lasers, electrical discharge machining, or cast. In other embodiments, the cooling passages may separate their respective components into separate parts.

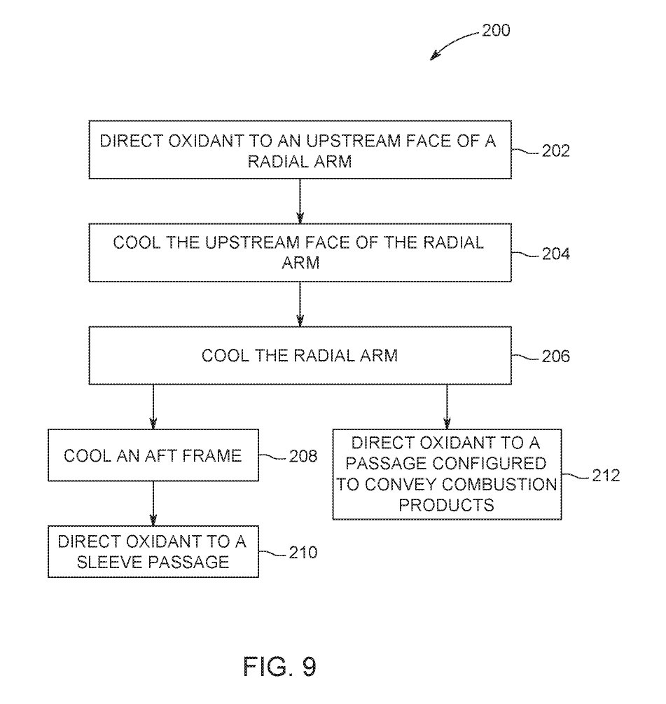

FIG. 9 is a flow chart illustrating an embodiment of a method 200 to cool the radial arm 114 of the web plate 36. Although the following method 200 describes a number of operations that may be performed, it should be noted that the method 200 may be performed in a variety of suitable orders. All of the operations of the method 200 may not be performed.

The method 200 includes directing (block 202) a portion of the oxidant 60 from the compressor discharge casing 28 to the upstream face 134 of the radial arm 114 of the web plate 36. The web plate 36 is disposed axially between the transition piece 32 and the turbine nozzle 34. The oxidant 60 is directed to the radial arm 114 to cool (block 204) the upstream face 134 of the radial arm 114. In some embodiments, the oxidant 60 is directed through impingement ports 157 of the impingement plate 156 to cool (block 204) the upstream face 134 of the radial arm 114 via impingement cooling. One or more arm passages 172, 173, 174, and 175 into the radial arm 114 receive the oxidant 60 from the upstream face 134 to cool (block 206) the radial arm 114. The arm passages 172 and 174 extend in the axial direction 72 from the upstream face 134 of the radial arm 114. Then, the method 200 includes two options. In some embodiments, the oxidant 60 from the arm passage through the radial arm 114 cools (block 208) the aft frame 106. For example, the first arm passage 173 may direct the oxidant 60 to the first aft frame cooling passage 176, and the second arm passage 175 may direct the oxidant 60 to the second aft frame cooling passage 178. The oxidant 60 routed through the aft frame cooling passages 176, 178 cools (block 208) the aft frame 106. The oxidant 60 through the aft frame cooling passages 176, 178 may be directed (block 210) to the sleeve passage 64 disposed about the transition piece 32. That is, the oxidant 60 through the aft frame cooling passages 176, 178 may be directed (block 210) in the upstream direction. In some embodiments, the oxidant 60 through the arm passages 172, 174 is discharged (block 212) from the radial arm 114 to the passage 82. The passage 82 is configured to convey combustion products 61 and the discharged oxidant 60 through the transition piece 32, the web plate 36, and the turbine nozzle 34.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system comprising:
a web plate axially disposed between a transition piece and a turbine nozzle, wherein the web plate comprises:
a radial arm extending in a radial direction between an inner surface and an outer surface of the web plate, wherein the radial arm, the inner surface, and the outer surface are disposed about an axial passage configured to facilitate a flow of combustion products from the transition piece to the turbine nozzle, wherein the transition piece is disposed within a compressor discharge cavity configured to receive an oxidant, and the radial arm comprises:
an upstream face in fluid communication with the compressor discharge cavity; and
an arm passage that extends an axial length in an axial direction from the upstream face through at least an axial depth of the radial arm, wherein the arm passage is configured to receive a portion of the oxidant through the upstream face.

2. The system of claim 1, comprising an aft frame coupled to the transition piece, wherein the aft frame comprises a cooling passage configured to receive the portion of the oxidant directly from the arm passage of the radial arm.

3. The system of claim 2, comprising:
a second sealing element disposed between the aft frame and the radial arm upstream of the cooling passage relative to the flow of combustion products; and
a third sealing element disposed between the aft frame and the radial arm downstream of the cooling passage relative to the flow of combustion products.

4. The system of claim 2, comprising:
the transition piece; and
a sleeve disposed about the transition piece, wherein the sleeve and the transition piece form a sleeve passage within the compressor discharge cavity, wherein the sleeve passage is configured to receive the portion of the oxidant from the cooling passage of the aft frame.

5. The system of claim 2, wherein the cooling passage extends within the aft frame along a skin region of the aft frame, wherein the skin region is adjacent to the axial passage and extends at least 25 percent of a circumferential depth of the aft frame from a combustion product surface of the aft frame.

6. The system of claim 1, comprising:
an aft frame coupled to the transition piece; and
a first sealing element disposed axially between the aft frame and the upstream face of the radial arm.

7. The system of claim 6, wherein the radial arm comprises:
an impingement plate disposed upstream of the upstream face relative to the flow of combustion products, wherein the impingement plate comprises a plurality of impingement ports configured to direct the portion of the oxidant toward the upstream face as a plurality of impingement flows.

8. The system of claim 6, wherein the first sealing element is continuous around the axial passage.

9. The system of claim 1, wherein the radial arm comprises a downstream face opposite the upstream face, the arm passage extends from the upstream face to the downstream face, and the axial length is greater than or equal to the axial depth of the radial arm, wherein the arm passage is configured to discharge the portion of the oxidant into the flow of combustion products.

10. A system comprising:
a web plate comprising:
a radial arm extending in a radial direction between an inner surface and an outer surface of the web plate, wherein the radial arm is circumferentially disposed between a first axial passage and a second axial passage, the first axial passage extends in an axial direction through a first transition piece, the web plate, and a first turbine nozzle, wherein the second axial passage extends through a second transition piece, the web plate, and a second turbine nozzle, wherein the first axial passage and the second axial passage are configured to convey combustion products, wherein the first transition piece and the second transition piece are disposed within a compressor discharge cavity configured to receive an oxidant,
wherein the radial arm comprises:
a first arm passage configured to receive a first portion of the oxidant through a body of the radial arm; and
a second arm passage configured to receive a second portion of the oxidant through the body of the radial arm.

11. The system of claim 10, comprising:
a first aft frame coupled to the first transition piece, wherein the first aft frame comprises a first cooling passage configured to receive the first portion of the oxidant from the first arm passage; and
a second aft frame coupled to the second transition piece, wherein the second aft frame comprises a second cooling passage configured to receive the second portion of the oxidant from the second arm passage.

12. The system of claim 11, comprising:
a first sealing element disposed axially between the first aft frame and an upstream face of the radial arm, wherein the upstream face is in fluid communication with the compressor discharge cavity, and the first arm passage and the second arm passage extend in the axial direction from the upstream face;
a second sealing element disposed axially between the second aft frame and the upstream face of the radial arm;
a first sealing member disposed between the first aft frame and the radial arm upstream of the first cooling passage relative to the combustion products;
a second sealing member disposed between the first aft frame and the radial arm downstream of the first cooling passage relative to the combustion products;
a third sealing member disposed between the second aft frame and the radial arm upstream of the second cooling passage relative to the combustion products; and
a fourth sealing member disposed between the second aft frame and the radial arm downstream of the second cooling passage relative to the combustion products.

13. The system of claim 12, wherein the first sealing member, the second sealing member, the third sealing member, and the fourth sealing member comprise rope seals, bellow seals, w-seals, or any combination thereof.

14. The system of claim 12, wherein the radial arm comprises:
an impingement plate disposed upstream of the upstream face relative to the flow of combustion products, wherein the impingement plate comprises a plurality of impingement ports configured to direct the first portion and the second portion of the oxidant toward the upstream face as a plurality of impingement flows.

15. The system of claim 10, wherein the radial arm comprises:
an upstream face in fluid communication with the compressor discharge cavity; and
a downstream face opposite the upstream face, wherein the first arm and the second arm passage extend from the upstream face to the downstream face, wherein the first arm passage and the second arm passage are configured to discharge the first portion and the second portion of the oxidant from the downstream face into the combustion products.

16. The system of claim 15, wherein the radial arm comprises:
an impingement plate disposed upstream of the upstream face relative to the flow of combustion products, wherein the impingement plate comprises a plurality of impingement ports configured to direct the first portion and the second portion of the oxidant toward the upstream face as a plurality of impingement flows.

17. The system of claim 10, wherein at least one of the first arm passage and the second arm passage extend within the radial arm along a skin region of the radial arm, wherein the skin region extends at least 25 percent of an axial depth of the radial arm from a downstream face of the radial arm.

18. A method comprising:
directing a portion of an oxidant to an upstream face of a radial arm of a web plate, wherein the web plate is disposed axially between a transition piece and a turbine nozzle; and
cooling the radial arm of the web plate by directing the portion of the oxidant through one or more passages extending in an axial direction from the upstream face of the radial arm.

19. The method of claim 18, comprising cooling the upstream face of the radial arm via impingement cooling, wherein the radial arm comprises an impingement plate comprising a plurality of impingement ports.

20. The method of claim 18, comprising:
cooling an aft frame by directing the portion of the oxidant through a cooling passage of the aft frame, wherein the aft frame is configured to receive the portion of the oxidant from the one or more passages of the radial arm; and
directing the portion of the oxidant from the cooling passage of the aft frame to a sleeve passage disposed about the transition piece.

21. The method of claim 18, comprising directing the portion of the oxidant through the radial arm to a passage configured to convey combustion products through the transition piece, the web plate, and the turbine nozzle.
